(19) United States
(12) Patent Application Publication
(10) Pub. No.: US 2012/0166294 A1
(43) Pub. Date: Jun. 28, 2012

(54) SYSTEM AND METHOD FOR SKIPPABLE PRE-ROLL VIDEO ADVERTISING

(76) Inventors: Todd Lieberman, Haverford, PA (US); Ari Jacoby, New York, NY (US); Jeff Weisberg, Philadelphia, PA (US); John Cappiello, Blue Bell, PA (US)

(21) Appl. No.: 13/411,067

(22) Filed: Mar. 2, 2012

Related U.S. Application Data
(63) Continuation-in-part of application No. 12/917,948, filed on Nov. 2, 2010.
(60) Provisional application No. 61/257,284, filed on Nov. 2, 2009.

(51) Int. Cl. G06Q 30/02

(52) U.S. Cl. 705/14.72

(57) ABSTRACT

A system and method for presenting a skippable pre-roll interactive advertisement (e.g., a pre-roll video). The interactive advertisement is configured to be presented in advance of content requested by a user and convey a brand message to a user while at the same time providing the user with an associated type-in challenge (i.e., a challenge or question relating to the pre-roll advertisement) which, if answered appropriately, allows the user to skip or bypass the pre-roll advertisement and advance to the desired content. The user response to the interactive advertisement may be collected and utilized to generate marketing reports which illustrate the effectiveness of an interactive advertisement in conveying an advertiser's message.

### CROSS-REFERENCE TO RELATED APPLICATIONS

This application is a continuation in part of U.S. patent application Ser. No. 12/917,948, filed on Nov. 2, 2010, titled “System and Method for Generating and Managing Interactive Advertisements,” which claims the benefit of U.S. Provisional Patent Application No. 61/257,284, filed on Nov. 2, 2009, titled “Brand Marketing Attention System and Micropayment Platform,” both of which are herein incorporated by reference.

### FIELD OF THE INVENTION

The present invention relates generally to a method and system for generating and managing interactive advertisements. More specifically, embodiments of the present invention relate to a method and system for allowing a user to skip a pre-roll advertisement (e.g., a video advertisement presented in advance of content requested by the user) based on the user's response to the pre-roll advertisement.

### BACKGROUND OF THE INVENTION

Internet users have become increasingly desensitized to online advertising. These users often fast forward through video ads, ignore online banner ads and speed past interstitial pages. Years of exposure to various forms of online advertisements have left users adept at blocking out unwanted information while accesses information online or through other electronic media outlets.

Even as users decrease the attention given to online advertisements, many marketers are increasing their online advertisement budgets, collectively spending billions of dollars in an effort to capture the attention of online users. The increase in online advertising budgets reflects consumers' shift away from traditional media outlets, such as television, newspapers, and magazines, to the Internet and other electronic mediums.

With the significant rise of Internet usage over the last decade, online Publishers, e-commerce websites or their website hosts, collectively referred to as “publishers,” have become increasingly concerned with methods to capture the attention of online users and communicate brand messages, even though such users may be more focused on bypassing Internet advertising and instead progressing to view user-selected content. Publishers have also become increasingly concerned with online security, in particular unauthorized website access by Internet robots (i.e., non-human entities), or simply “bots.” A bot is a software application configured to run automated tasks over the Internet. A bot may be configured to artificially increase the traffic generated by a given website or perform other unwanted actions on a website.

To combat the problem of unauthorized website access by bots, publishers implement simple challenge and response tests, otherwise known as a Captcha, to confirm a request for access originates from a human user instead of a bot. To access additional content on a website implementing a Captcha, the user is required to view an image containing a portion of text and input the portion of text into a provided textbox. The portion of text within the Captcha is often blurred, skewed, or altered in some fashion to prohibit a bot from correctly identifying the text using standard optical scanning techniques. The text included in a Captcha is randomly selected and conveys no useful information to the user and provides no revenue to the publishers.

The process of completing a Captcha requires the user to commit a few seconds of attention on a specific image and respond to the image by physically entering text into a textbox. Unlike banner ads or online video ads where users are not forced to engage with the content, Captchas required a certain level of attention from a user to correctly identify and input the displayed text satisfactorily to overcome the challenge and enter the desired site. As a result, users may spend more time focused on the text within a Captcha than reading a paid-for banner ad displayed on the same webpage. Currently, from the perspective of an online advertiser, the time users spend focused on each Captcha represent a lost opportunity to reach potential customers.

As a result, there is a need in the art for a method and system to integrate an advertisement into a Captcha to create an interactive advertisement. There is also a need in the art for a method and system capable of ensuring that an advertiser's key branding message is absorbed by a viewer of an Internet advertisement, even though such viewer may be more interested in skipping over the advertisement and progressing to other user-selected content.

### SUMMARY OF THE INVENTION

Embodiments of the present invention satisfy these needs and others by providing a method and system for generating interactive advertisements. As used herein, the term “interactive advertisement” includes, but is not limited to, an electronic media configured to convey a branded message from an advertiser to a user configured to allow the user to engage or interact with the electronic media. The interactive advertisement may include at least a media segment and a user input segment. The media segment comprises an advertisement for presenting to a user, including but not limited to, a puzzle, a game, text, video or any other media. The user input segment may be any suitable interface configured to allow the user to engage with the interactive advertisement and receive a user response provided by the user in relation to the media segment, such as, for example, a textbox, a drop down menu, a radio button, etc.

In an embodiment, the interactive advertisement is displayed in advance of underlying content requested and desired by the user. For example, the interactive advertisement or “pre-roll advertisement” includes a pre-roll video advertisement which plays prior to displaying a video requested by the user. In addition to conveying a brand message, the interactive advertisement (e.g., pre-roll video advertisement) presents the user with the user input segment (i.e., a type-in field) that enables the user/viewer of the interactive advertisement to skip at least a portion of the underlying pre-roll advertisement while having the brand message reinforced upon the viewer. In addition, the pre-roll advertisement related challenge may be used to provide security for the website and/or the underlying content which is displayed following the pre-roll video advertisement. In an embodiment, the interactive advertisement may require a user to provide a specific user response in order to skip at least a portion of the pre-roll advertisement and gain access to the underlying content of the given website. For example, a website may display an interactive advertisement containing a branded message presenting a user with the following brand message, “Our Diet Soft Drink Has Zero Calories,” and then present a prompt or a challenge to the user to provide a user response stating “the number of calories” contained in the advertised soft drink. In this example, the user is denied access to the requested content and is obliged to continue to view the pre-roll video advertisement unless or until the user enters “zero” as his or her response. Entry of a correct answer to the challenge by the user (e.g., the user entering “zero” in the type-in field) allows the user to skip the pre-roll video advertisement and advance to the desired underlying content. Alternatively, the user may be required to provide the entire phrase “Our Diet Soft Drink Has Zero Calories” as a user response to overcome the pre-roll skip/access challenge associated with the interactive advertisement.

In another example, a website may display an interactive video advertisement that functions as a pre-roll advertisement (i.e., a short video advertisement that plays before other target content). In an example, the pre-roll advertisement may be a commercial for a camera that has a “36× zoom lens.” The user may be presented with the option to skip a portion of the pre-roll advertisement by being prompted to type in a brand message such as “36× Zoom” into a text box within the pre-roll advertisement. Once the user types in the correct message, the pre-roll advertisement ends and the user is able to skip to the target content. The type-in component of an interactive video advertisement reinforces brand messaging and results in measurable brand lift superior to traditional video-only pre-roll advertisements.

A publisher of a website may seek to implement web security by confirming that a request for a webpage originates from a human user, and not a bot, while at the same time generating advertising revenue. To achieve both web security and revenue generation, the publisher may incorporate an interactive advertisement into a webpage of the website, wherein a user must adequately response to a challenge associated with the interactive advertisement to receive addition webpages from the publisher. According to an embodiment of the present invention, the publisher requests the generation of an interactive advertisement to be displayed on the publisher's website. Depending on the level of security and advertising revenue desired by the publisher, the subject matter of the website, and/or other publisher attributes, an advertiser is selected from a pool of advertisers and a interactive advertisement is generated based on a plurality of advertising parameters corresponding to the selected advertiser.

Embodiments of the present invention allow an advertiser to define a plurality of advertising parameters that may be used to generate an interactive advertisement. The plurality of advertising parameters define the appearance and, in certain respects, the functionality of the interactive advertisement. The interactive advertisement is generated and displayed to the user. If the user provides a correct user response (i.e., satisfactorily responding to the challenge presented by the interactive advertisement) in reply to the interactive advertisement, the publisher may assume the user is not a bot and therefore serve additional content to the user. If an incorrect user response is received, the publisher may restrict access to the given user or provide an alternative interactive advertisement to allow the user an additional opportunity to solve the challenge associated with the interactive advertisement. The user responses may be collated and stored for later use in generating analytics reports (e.g., marketing or advertising reports).

According to an embodiment of the present invention, an interactive advertisement may be configured to operate as a video pre-roll advertisement skipping tool by capturing a user response based on a branding message within the pre-roll advertisement and then skipping ahead to other video content from the publisher.

In alternative embodiments of the present invention, an interactive advertisement may be configured to capture a user response, but does not require the user to satisfactorily solve the challenge associated with the interactive advertisement in order to receive additional content from the publisher. Marketing reports created based on user responses may be used to analyze the effectiveness of a given advertising campaign or slogan, user retention of product messages, and/or brand preferences.

An embodiment of the present invention provides for confirming a request from access to a web element is initiated by a human by, identifying an advertiser based on a user dataset, retrieving a plurality of advertising parameters corresponding to the identified advertiser, generating based on the plurality of advertising parameters the interactive advertisement comprising a media segment and a user input segment configured to receive the user response, transmitting the interactive advertisement to the user, receiving the user response, and verifying the user response based on a portion of the plurality of advertising parameters.

### BRIEF DESCRIPTION OF THE DRAWINGS

The present invention will be more readily understood from the detailed description of exemplary embodiments presented below considered in conjunction with the attached drawings, of which:

FIG. 1 illustrates an exemplary system for generating an interactive advertisement, according to an embodiment of the present invention;

FIG. 2 illustrates an exemplary method for generating and implementing an interactive advertisement, according to an embodiment of the present invention;

FIG. 3a illustrates examples of interactive advertisements, according to an embodiment of the present invention;

FIG. 3b illustrates an exemplary interactive advertisement, according to an embodiment of the present invention;

FIG. 4 illustrates an exemplary method for generating a marketing report, according to an embodiment of the present invention; and

FIG. 5 illustrates an exemplary marketing report generating according to an embodiment of the present invention.

### DETAILED DESCRIPTION OF THE DRAWINGS

Embodiments of the present invention relate to a system and method for creating an interactive advertisement. An interactive advertisement is configured to include a media segment and a user input segment. The media segment represents a portion of the interactive advertisement comprising the advertising content and may include any one or more of text, ad copy, puzzle, or other branded message to be displayed or otherwise presented to the user. The user input segment represents a portion of the interactive advertisement where the user may enter text, select an option, or otherwise interact or engage with the interactive advertisement. Requiring a user to read or listen to the media segment and respond via the user input segment, increases the focus a user gives to the advertising content brand message included in the interactive advertisement, as compared to a conventional online advertisement. As a result the interactive advertisement provides greater value and a stronger impression to an advertiser. In addition, verifying if a user adequately response to the challenge associated with an interactive advertisement provides web security by identifying a user as human, as compared to a bot.

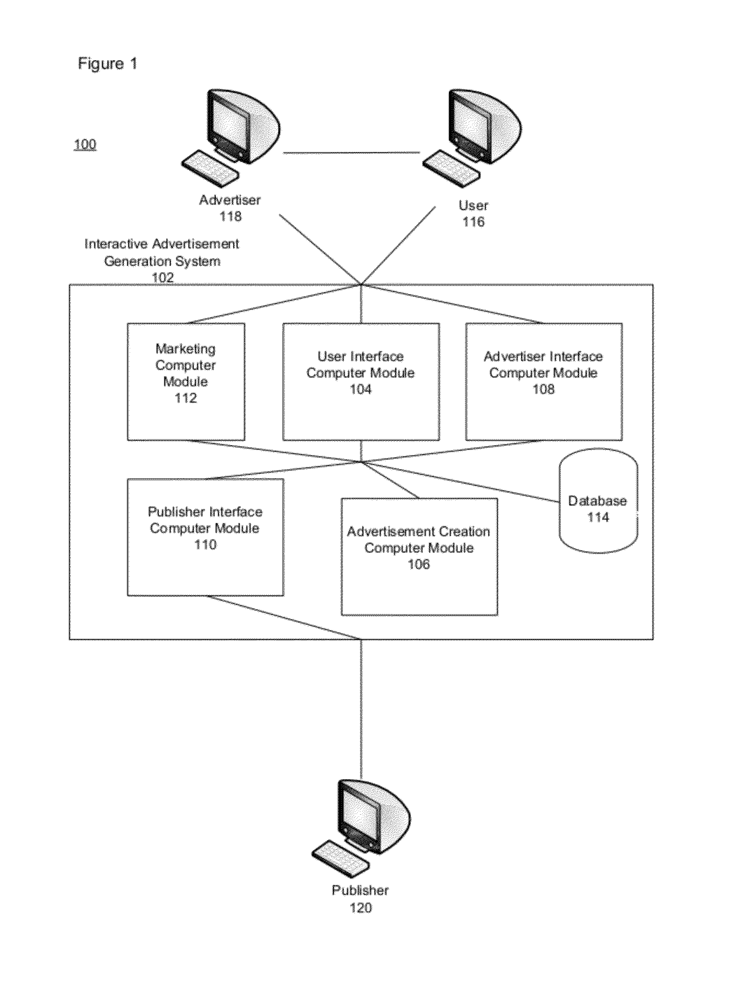

FIG. 1 illustrates an exemplary Data Network 100 including an exemplary environment comprising an Interactive Advertisement Generation System 102 according to an embodiment of the present invention. According to the present invention, the Interactive Advertisement Generation System 102 comprises a User Interface Computer Module 104, an Advertisement Creation Computer Module 106, an Advertiser Interface Computer Module 108, a Publisher Interface Computer Module 110, a Marketing Computer Module 112, a Database 114 communicatively connected to a User 116, an Advertiser 118 and a Publisher 120. As used herein, the term “computer module” is intended to include, but is not limited to, any data processing device, such as a desktop computer, a laptop computer, a mainframe computer, a personal digital assistant, a server, a handheld device, or any other device able to process data configured to execute one or more software programs configured to perform one or more functions. The aforementioned components of the Data Network 100 and the Interactive Advertisement Generation System 102 represent computer hardware and computer-implemented software configured to perform the functions described in detail below. One having ordinary skill in the art will appreciate that the components of the Interactive Advertisement Generation System 102 may be implemented on one computer or a multiple computers communicatively connected computers. The term “communicatively connected” is intended to include, but is not limited to, any type of connection, whether wired or wireless, in which data may be communicated, including, for example, a connection between devices and/or programs within a single computer or between devices and/or programs on separate computers. The exemplary Data Network 100 shown in FIG. 1 illustrates includes only one user, publisher, and advertiser, however multiple users, publishers, and advertisers may interact via the Interactive Advertisement Generation System 102.

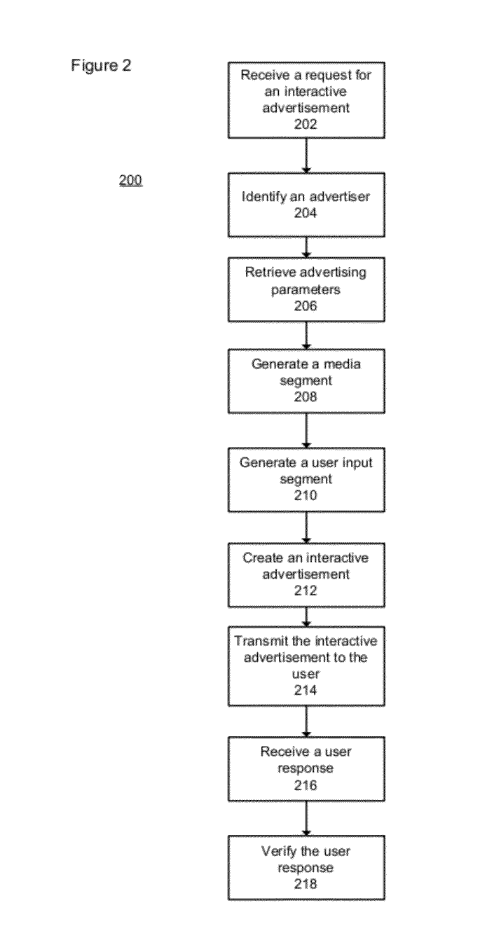

The features and functionality according to embodiments of the Interactive Advertisement Generation System 102 and its components are described in detail in connection with the system diagram of FIG. 1 and the process flow diagram of FIG. 2. As illustrated in FIG. 1, one or more user computers (e.g., User 116) are communicatively connected to the Publisher 120 and the Interactive Advertisement Generation System 102. As user herein, the one or more websites (e.g., Publisher 120) may include any website or electronic resource provider configured to provide content to the User 116. For example, the Publisher 120 may be an online newspaper configured to transmit electronic news articles to the User 116. Alternatively, the Publisher 120 may be an e-commerce website selling concert tickets, books, digital content, or any other product or service.

According to an embodiment of the present invention wherein the Publisher 120 is an online newspaper, the User 116 may access the Publisher 120 to download a specific news article. To provide security from unauthorized access, the Publisher 120 may require the User 116 to successfully interact with a challenge provided via or in the form of an interactive advertisement prior to accessing the specific news article. In response to a request for content, the Publisher 120 transmits to the User 116 a webpage wherein the webpage configured to direct the web browser of the User 116 to download an interactive advertisement from the Interactive Advertisement Generation System 102.

According to the embodiment of the present invention, as illustrated in FIG. 2, method 200 begins at step 202 by receiving a request for an interactive advertisement from the User 116. The Interactive Advertisement Generation System 102, specifically the User Interface Computer Module 104, is communicatively connected to the User 116 and is configured to receive a request for an interactive advertisement. The request may come from the browser of the User 116, triggered by a webpage provided to the User 116 by the Publisher 120. The Publisher 120 may transmit a webpage to the User 116 wherein the webpage may include Java Script or other like computer code configured to retrieve and display to the User 116 an interactive advertisement. According to an embodiment of the present invention, the interactive advertisement acts as a security measure by requiring the User 116 to adequately answer a question or a solve puzzle presented by the interactive advertisement prior to providing access to additional content from the Publisher 120.

According to an embodiment of the present invention, the request for an interactive advertisement comprises a user dataset. The term “user dataset” is intended to include, but is not limited to, one or more data points implicitly or explicitly provided by a user or software running on the user's computer which may identify the webpage that triggered the request for the interactive advertisement, the user's web browsing history, demographic information, computer configuration, location, or any other information which may be relied on when generating an interactive advertisement. In the case of video content, a user dataset may include attributes related to the content the user is attempting to view. For example, the fact that a user is viewing a video related to “cars” may be included within the user dataset. Portions of the user dataset may be based on cookies, computer configuration files, or other information stored on the computer of the User 116.

Following receipt of the request for an interactive advertisement at step 202, method 200 continues at step 204 by identifying an advertiser. According to the embodiment of the present invention illustrated in FIG. 1, the Advertiser Interface Computer Module 108 is configured to select an advertiser that will determine the content of the interactive advertisement. The Advertiser Interface Computer Module 108 may consider one or more portions of the user dataset to identify an appropriate advertiser. For example, the Advertiser Interface Computer Module 108 may analyze a user dataset to determine that the User 116 is located in the New York metropolitan area and regularly visits sports related websites. As a result, the Advertiser Interface Computer Module 108 may search the Database 114 for advertisers to identify an advertiser interested in reaching sports fans within the New York metropolitan area. When an advertiser (e.g., Advertiser 118) establishes an advertising campaign with the Interactive Advertiser Generation System 102, the Advertiser 118 can specify the target market or markets they wish to reach. In addition, the Advertiser 118 may identify the field in which their advertisements are directed, such as, consumer electronics, travel, healthcare, etc. The Advertiser Interface Computer Module 108 is configured to match a user with an advertiser based in part on the user dataset and the preference(s) defined by the advertiser.

In addition, the Publisher 120 may communicate with the Publisher Interface Computer Module 110 to specify the type of advertisers the Publisher 120 would like to include on their website. For example, the Publisher 120 may be an online newspaper with a focus on leisure activities. As a result, the Publisher 120 may specify that interactive advertisements from advertisers within the fields of Arts and Entertainment, Travel, and Sports are acceptable content to be displayed on the website of the Publisher 120.

Using the Publisher Interface Computer Module 110, the Publisher 120 may create a profile identifying preferences regarding the advertisers and/or advertisement fields eligible for inclusion on the Publisher's 120 website or portions of a website. In an embodiment of the present invention wherein the Publisher 120 is an online newspaper covering a wide array of topics, the Publisher 120 may identify an advertisement field as acceptable for the sports section but unacceptable for the fashion section. As a result, the Publisher 120 can customize preferences to ensure the subject matter of an interactive advertisement displayed in conjunction with their website is appropriate for the forum and intended audience.

Furthermore, the Publisher 120 may specify the security rating corresponding to the interactive advertisements displayed on the Publisher's 120 website. As described above, an interactive advertisement may provide security for the Publisher's 120 website by requiring the User 116 viewing the interactive advertisement to satisfactorily responding to the challenge presented by the interactive advertisement prior to accessing certain content on the Publisher's 120 website. The more difficult an interactive advertisement for a bot to supply a satisfactory response the more security the interactive advertisement provides, and accordingly a higher security rating is assigned to the interactive advertisement. To create a more secure interactive advertisement, the visual complexity of the interactive advertisement is increased by altering the text and/or background of the interactive advertisement or including image noise into the background of the interactive advertisement. Increasing the visual complexity of an interactive advertisement reduces the ability of a bot to correctly decipher the text included in the interactive advertisement and therefore reduces the ability for a bot to adequately respond to the interactive advertisement. However, increasing the visual complexity of an interactive advertisement also reduces the readability of the branded message by human users and therefore decreases the value of the interactive advertisement to an advertiser. As a result, when selecting the desired security rating for interactive advertisements displayed on a given website, a Publisher 120 must balance the desired level of security provided by an interactive advertisement with a desired level of clarity in the presentation of the interactive advertisement. In the event an interactive advertisement for a given advertiser can not be created to meet the security/revenue balance specified by the Publisher 120, an alternative advertiser will be selected.

Following the use of the Advertisement Interface Computer Module 108 and the Publisher Interface Computer Module 110 to identify an advertiser, method 200 continues by retrieving advertising parameters, at step 206. As used herein, the term “advertising parameter” is intended to include, but is not limited to, one or more options characteristics, definitions, rules, and/or other information defined by an advertiser for use in the creation of an interactive advertisement relating to the advertiser. The advertising parameters specify the appearance and functionality of an interactive advertisement as well as the cost the Advertiser 118 is willing to pay to Publisher 120 for displaying the interactive advertisement. According to certain embodiments of the present invention, the Advertiser 118 connects to the Advertiser Interface Computer Module 108 through a web interface to configure the advertising parameters. The Advertiser 118 may utilize the Advertiser Interface Computer Module 108 to view, update and edit the advertising parameters via any conventional graphical user interface, and the advertiser-set advertising parameters are stored by the Interactive Advertisement Generation System 102.

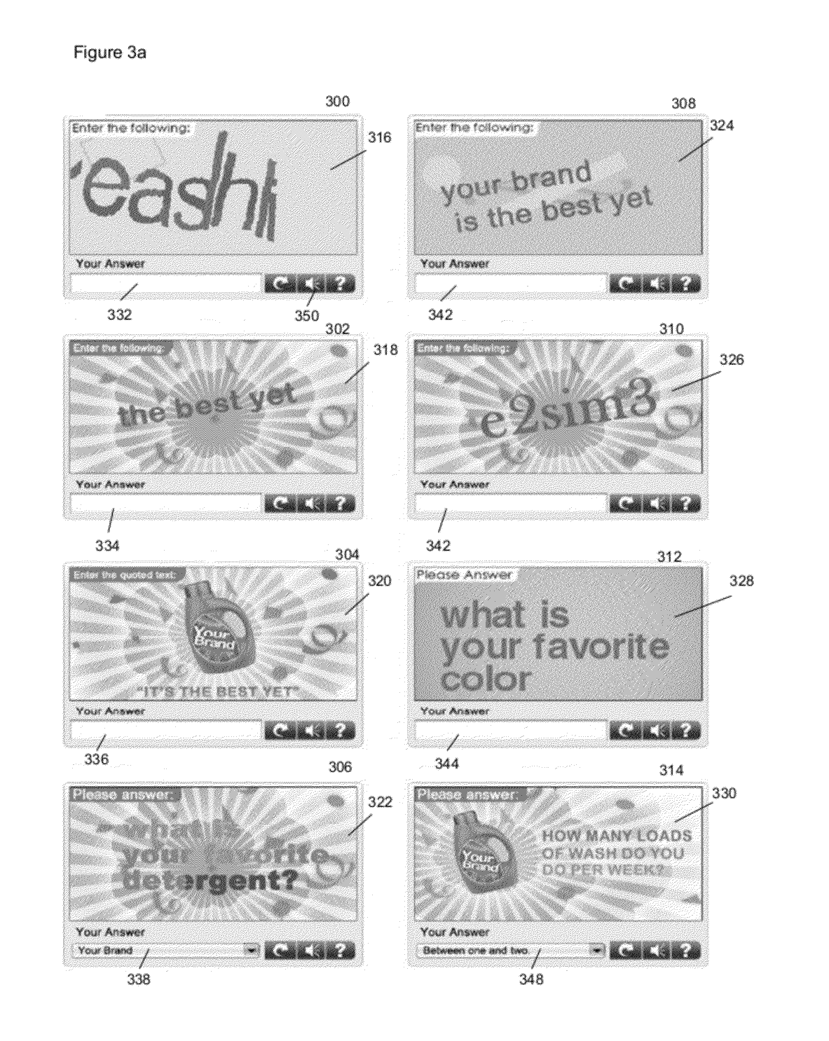

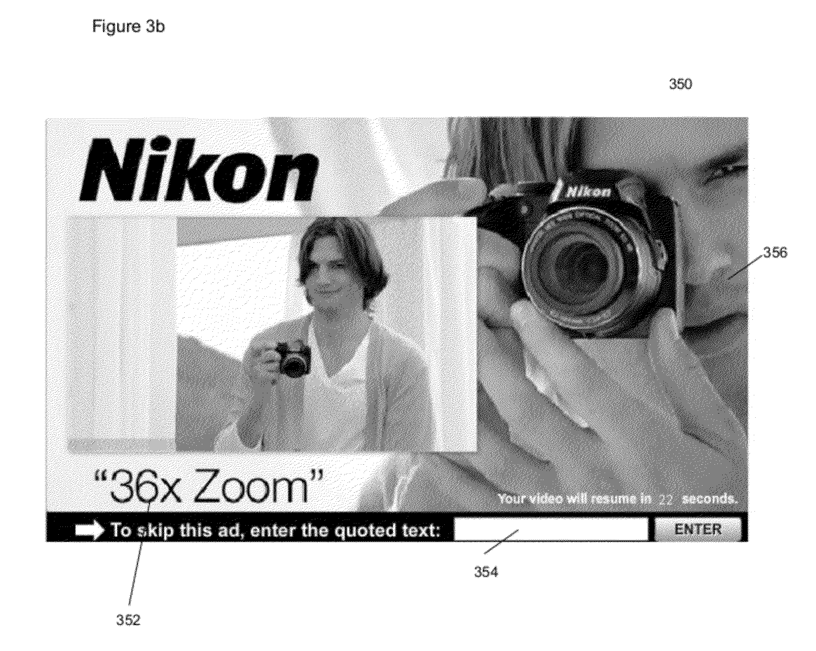

According to certain embodiments of the present invention, there are two types of interactive advertisement: a type-in interactive advertisement and an impression interactive advertisement. A type-in interactive advertisement provides a user with a text box to allow the user to interact with the interactive advertisement by typing text into the text box. As illustrated in FIG. 3a, interactive advertisements 300, 302, 304, 308 and 310 are examples of type-in interactive advertisements, according to an embodiment of the present invention. An impression interactive advertisement provides a user with a drop down menu, or other suitable selection mechanism, configured to allow the user to interact with the interactive advertisement by selecting an option from the drop down menu or other like interface. As illustrated in FIG. 3a, interactive advertisements 306 and 314 are all impression interactive advertisements. The Advertiser 118 may utilize a type-in interactive advertisement, impression interactive advertisement or a hybrid of the two depending on the goal of a given advertising campaign. The Advertiser 118 may utilize the one or more advertising parameters of a given advertiser to create the interactive advertisement and select the appropriate advertisement type.

According to certain embodiments of the present invention, the User 116 is required to view the interactive advertisement and reply to the interactive advertisement by entering a specific string or combination of text, or substantially similar string or combination of text, into a textbox or selecting a specific option from a drop down menu in order to gain access to certain content of the Publisher 120. Using the advertisement parameters, the Advertiser 118 defines the answer that must be provided by the User 116 to solve the interactive advertisement.

Furthermore, the Advertiser 118 may use the advertising parameters to identify a background image or text to be included in an interactive advertisement. For example, referring to FIG. 3a, the advertiser associated with the example Interactive Advertisement 302 provided the stylized background and text “the best yet” to be used when creating the Interactive Advertisement 302. The Advertiser 118 may upload an image file to be used as the background. In comparison, the advertiser responsible for the Interactive Advertisement 308 only provided the text “your brand is the best yet” and allowed the background to be randomly generated. According to certain embodiments of the present invention, the Advertiser 118 may create customized media content which includes both the background and the text as a single image, as illustrated in interactive advertisement 314.

FIG. 3b illustrates an exemplary pre-roll video skipping function, according to an embodiment of the present invention. Interactive Advertisement 350 represents a pre-roll advertisement which is a video advertisement for a Nikon® camera that plays before a second video, referred to herein as the “target video.” Item 356 represents the media segment which, in this case, is a video advertisement for a camera. Item 354 represents the user input segment. When a User 116 attempts to access target content (i.e., launches certain target content), Interactive Advertisement 350 begins. The User 116 is presented with a message similar to that shown at the bottom of the media segment 356, which, in this case, instructs the User 116 that in order to skip the Interactive Advertisement 350, the User 116 must perform a certain designated action (e.g., type in the brand message 352). In this example, the brand message 352 is the text “36× Zoom.” If the User 116 types the correct brand message 352 into the user input segment 354, the pre-roll video stops and the target video begins playing. Even though the User 116 may have viewed only a portion of the Interactive Advertisement 350, the brand message 352 is nevertheless impressed upon the User 116. The brand message 352 may include, without limitation, quoted text, a slogan, a product characteristic, or any other message that the Advertiser 118 wishes the User 116 to associate with the product or service being advertised.

According to certain embodiments of the present invention, the advertising parameters may allow for further customization of an interactive advertisement. For example, the advertisement parameters define the text size, text font, language, and/or provide a tracking pixel to be included in an interactive advertisement.

Following the retrieval of the advertising parameters from the Database 114, method 200 continues by generating a media segment, at step 208. Each interactive advertisement comprises a media segment and a user input segment. The media segment represents the portion of the interactive advertisement wherein the Advertiser 118 displays a message to the User 116. The user input segment represents the portion of the interactive advertisement configured to receive a user response from the User 116. For example, as illustrated in FIG. 3a, item 318 represents a media segment and item 334 represents a user input segment of the Interactive Advertisement 302.

According to certain embodiments of the present invention, the Advertisement Creation Computer Module 106 is configured to create the media segment. To create the media segment, the Advertisement Creation Computer Module 106 consults the retrieved advertising parameters to identify the text and background specified by the Advertiser 118. The Advertisement Creation Computer Module 106 creates an image by combining the identified text and background. If additional advertising parameters (e.g., text color, font, etc.) are provided, the Advertisement Creation Computer Module 106 alters the text accordingly. In the event that text, background, or both are not provided, the Advertisement Creation Computer Module 106 will supplement the deficiency by utilizing random text or background or by selecting appropriate text or background based on the advertiser. According to certain embodiments of the present invention wherein the Advertiser 118 provides customized media content such as pre-roll videos, the Advertisement Creation Computer Module 106 may utilize the customized media content as the media segment without adding additional text or background. Further embodiments of the present invention may allow the Advertiser 118 to specify the use of multiple images within a single media segment. In such an embodiment, the interactive media element cycles through the series of images when the interactive advertisement is displayed to the User 116.

To increase the security rating of an interactive advertisement, the visual complexity of the media segment may be altered to reduce the likelihood that a bot will be able to overcome security challenges associated the interactive advertisement. Such alterations may include blurring, skewing, or rotating the text included in the media segment, or altering the background. As described above, the Publisher 120 defines a desired security rating for an interactive advertisement displayed on the website of the Publisher 120, and in the event the media segment can not be visually altered to achieve the desired security rating, an alternative advertiser may be selected for the Publisher 120.

Following the generation of the media segment, method 200 continues by generating a user input segment, at step 210. As described above, the user input segment is configured to receive a user response. According to certain embodiments of the present invention, the Advertisement Creation Computer Module 106 is configured to generate the user input segment. As described above, an interactive advertisement may be a type-in interactive advertisement or an impression interactive advertisement, as specified by the advertising parameters. In an embodiment of the present invention wherein the advertising parameters specify a type-in interactive advertisement, the Advertisement Creation Computer Module 106 generates a user input segment comprising a text box configured to receive a user response. Alternatively, when generating an impression interactive advertisement, the Advertisement Creation Computer Module 106 creates a drop down menu comprising a plurality of options, wherein the advertising parameters define the options to be included. For example, according to the Interactive Advertisement 314, the advertising parameters may define the “Between one and two,” “Between two and five,” and “Over five” as possible answers to the question presented “How many loads of wash do you do per week?” As a result, the Advertisement Creation Computer Module 106 creates a user input segment comprising a drop down menu with the options of “Between one and two,” “Between two and five,” and “Over five.” The user input segment may also provide icons 350 that allow the user to request a different interactive advertisement, receive an audio message prompting the user to provide a user response, or access help information.

According to certain embodiments of the present invention, the Advertisement Creation Computer Module 106 is configured to generate the interactive advertisement, at step 212. The interactive advertisement is generated by combining the media segment and the user input segment into a single file. The generated interactive advertisement is assigned an identification number, or challenge ID. The challenge ID allows a user response to be linked to or associated with a given interactive advertisement, described in greater detail below.

According to an alternative embodiment of the present invention, a banner advertisement may be included in the interactive advertisement, in addition to the media segment. Given that the User's 116 focus will be directed to the media segment, locating a banner advertisement in close proximity to the media segment may capture a portion of the User's 116 attention, thereby providing addition value to an advertiser. The banner advertisement and the media segment may not necessary relate to the same product or advertiser.

Following the creation of the interactive advertisement, the User Interface Computer Module 104 transmits the interactive advertisement to the User 116. According to certain embodiments of the present invention, the User Interface Computer Module 104 may first transmit an initial data package comprising cookie information, display configuration information, and other data to the User 116 prior to transmitting the interactive advertisement. After the transmission of the initial data package, the User Interface Computer Module 104 transmits the interactive advertisement to the User 116. According the certain embodiments of the present invention, the interactive advertisement may be transmitted to the Users 116 together with the initial data package. The interactive advertisement may be rendered on the User's 114 display through use of a web browser or other software application. Once displayed, the User 116 will view the interactive advertisement and reply by providing a user response as prompted by the media segment. For example, in an embodiment of the present invention wherein the Interactive Advertisement 304 is transmitted, the User 116 should type the text “the best yet” into the text box. The phrase “the best yet” will represent the user response.

According to certain embodiments of the present invention, the user response is initially transmitted from the User 116 to the Publisher 120, given that the interactive advertisement is embedded within a webpage of the Publisher 120. In addition to the user response, the User 116 also provides the Publisher 126 with the challenge ID. The Publisher 120 forwards the user response and the challenge ID to the Interactive Advertisement Generation System 102, and the Publisher Interface Computer Module 110 receives the user response and challenge ID at step 216.

Following the receipt of the user response and challenge ID, method 200 concludes at step 218 wherein the user response is verified. Verification of the user response will vary depending on the interactive advertisement. According to an embodiment of the present invention wherein the advertisement parameters define a correct answer or an adequate response for a given interactive advertisement, verification comprises retrieving the correct or expected answer and determining if the user response matches, or substantially matches, the correct answer or adequate response. The challenge ID is used to identify the correct interactive advertisement and thereby retrieve the corresponding correct answer. The user response is then compared to the correct answer. If the user response matches the correct answer, the Interactive Advertisement Generation System 102 determines that the user has adequately responded to the interactive advertisement and the user response is deemed acceptable. Alternatively, if the user response does not match the correct answer, the user response is deemed unacceptable. The verification result of acceptable or unacceptable is returned to the Publisher 120, wherein the Publisher 120 may determine the appropriate action to take based on the verification result. In alternate embodiments, the user response may be analyzed by the system to allow skipping of a pre-roll advertisement to gain access to other desired content in accordance with FIG. 3b. In addition, the user response may be analyzed by the system for purposes of generating marketing reports or preventing or delaying access to other content.

In addition to verifying the accuracy of the user response, the Marketing Computer Module 112 may collect the user response for use in generating marketing reports, as discussed in greater detail below. In addition, the frequency with which the user satisfactorily responds to the challenge presented by the interactive advertisement may also be collected to determine the difficulty of a given interactive advertisement and the strength of the impression.

In an alternative embodiment of the present invention wherein the interactive advertisement does not specify a correct answer, the User 118 is not required to satisfactorily respond to the interactive advertisement. In such an embodiment, verification may include collection of the user response by the Marketing Computer Module 112 for use as marketing and brand recognition data. In such an embodiment, the Marketing Computer Module 112 may collect the user response information and provide to the Publisher 126 a verification result identifying the user response as acceptable, despite not comparing the user response against a correct answer.

As described above, the Marketing Computer Module 112 is configured to collect the responses provided by the plurality of users that reply to the interactive advertisements generated by the Interactive Advertisement Generation System 102. The Marketing Computer Module 112 may store the user responses in Database 114 for later analysis in connection with the generation of marketing reports.

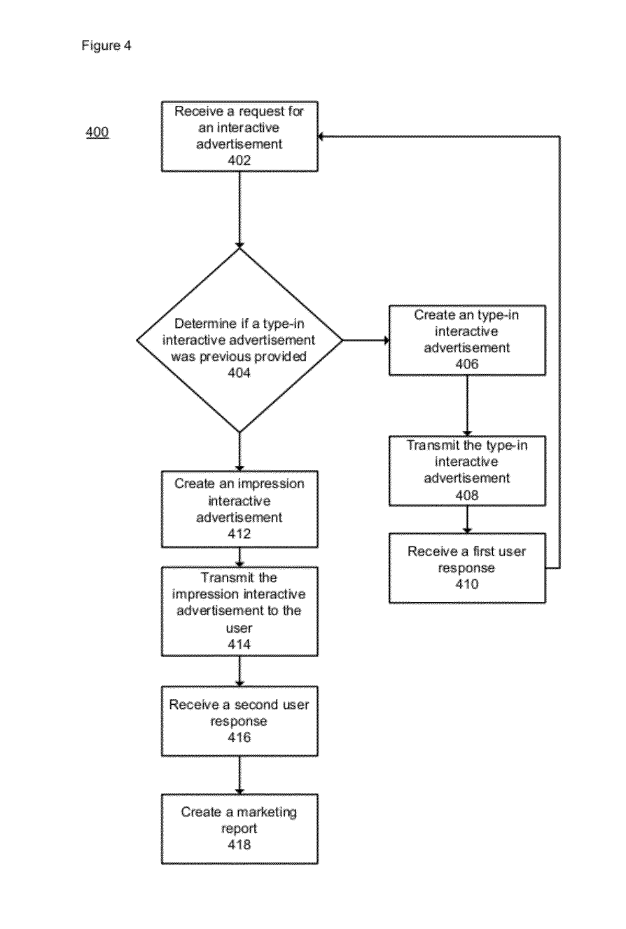

According to an embodiment of the present invention, FIG. 4 illustrates a method 400 for generating a marketing report based on a plurality of user responses. The marketing report created by method 400 is intended to analyze the effectiveness of a type-in interactive advertisement. In order to create a marketing report according to method 400, the Advertiser Interface Computer Module 108 is configured to allow the Advertiser 118 to request the creation of a series of corresponding interactive advertisements, more specifically, for the creation of a type-in interactive advertisement and a related impression interactive advertisement where the questions presented are related. For example, if the Advertiser 118 is marketing diet soft drinks, the User 116 may first be presented with a type-in interactive advertisement stating “Diet Drink ABC Has Zero Calories” and the Interactive Advertisement Generation System 102 may require the User 116 to type in a user response of “zero” or “0.” This initial type-in interactive advertisement educates the User 116 about a given product. At a later time, when the User 116 requests a subsequent interactive advertisement, the Advertisement Creation Computer Module 106 may determine that the User 116 had previously been displayed the type-in advertisement related to the diet soft drink and as a result, display a corresponding impression interactive advertisement stating “How Many Calories Does Diet Drink ABC Have?” while providing the User 116 with a drop down menu populated with the options “0,” “10,” “25” and “100.” The User 118 was previously exposed to the correct answer of “0” while completing the type-in interactive advertisement and therefore should respond adequately to the impression advertisement at a higher rate than users who were not previously exposed to the corresponding type-in interactive advertisement. Asking related questions provides brand reinforcement as well as generates data to gauge the effectiveness of the original type-in interactive advertisement.

According to the embodiment of the present invention described in FIG. 4, method 400 begins at step 402 by receiving a request for an interactive advertisement. An advertiser is selected in a similar fashion as described above in step 204 of FIG. 2. However, according to method 400, the Advertiser 118 elects to provide the User 116 with a series of related interactive advertisements, including, a type-in interactive advertisement and an impression interactive advertisement.

After receiving the request for an interactive advertisement and selecting an advertiser with an advertising campaign that includes a series of related interactive advertisements, method 400 continues by determining at step 404 if the User 116 has previously been provided the type-in interactive advertisement, which represents the first interactive advertisement in the series.

If the User 116 has not yet viewed the type-in interactive advertisement, method 400 continues by creating the type-in interactive advertisement, at step 406, and transmitting the same to the user at step 408. The User 116 views the type-in interactive advertisement, and, method 400 continues at step 410 by receiving the User's 116 user response in reply to the type-in interactive advertisement. The user response is stored in the Database 114 for later use when generating the marketing report.

According to the embodiment of the present invention in FIG. 4, method 400 continues at step 402 by receiving a request from the User 116 for a subsequent interactive advertisement. The User 116 is identified, at step 404, as having previously viewed the type-in interactive advertisement, and therefore method 400 continues to step 412, wherein the related impression interactive advertisement is generated. As described above, the related impression interactive advertisement may present to the User 116 a question similar to that which was displayed in the type-in interactive advertisement. The impression interactive advertisement is transmitted to the User 116 at step 414 and the related user response is received at step 416. The user response is stored to the Database 114 for later use when creating a marketing report. The series of related interactive advertisements are displayed to a plurality of users with all of the corresponding user responses stored in the Database 114.

In addition to exposing users to the type-in interactive advertisement followed by the related impression interactive advertisement, some users are simply exposed to the impression interactive advertisement without first being “educated” by the type-in interactive advertisement. Collecting data regarding users who are only exposed to the impression interactive advertisement allows for the effectiveness of the type-in interactive advertisement to be more accurately measured.

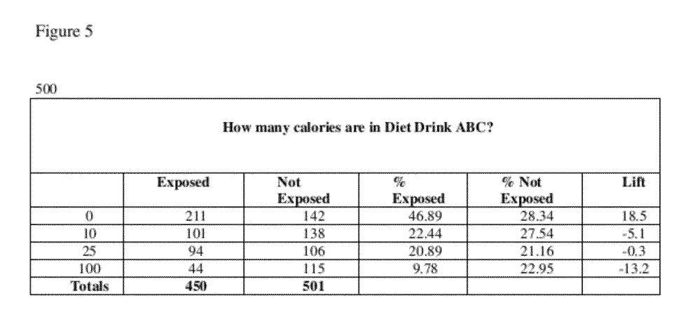

According to the embodiment of the present invention described in FIG. 4, method 400 concludes at step 418 by generating a marketing report based on the user responses to the related interactive advertisements. In FIG. 5, an exemplary Marketing Report 500 is shown which correlates the user responses. The Marketing Report 500 displays the data corresponding to the user responses to the impression interactive advertisement. The Marketing Report 500 separates the users into two user categories; “exposed” and “not exposed.” Exposed users represent user who where previously exposed to the type-in interactive advertisement before viewing the impression interactive advertisement and the not exposed users are users who were not exposed to the type-in interactive advertisement before viewing the impression interactive advertisement. The Marketing Report 500 allows the Advertiser 118 to track and measure the effect a type-in interactive advertisement may have on educating a user. The Marketing Report 500 identifies the number and percentage of exposed users that satisfactorily respond to the impression interactive advertisement as compared to the not-exposed users. Furthermore, the Marketing Report 500 quantifies the lift, or increase in users that satisfactorily respond to the impression interactive advertisement, provided by exposing a user to the type-in interactive advertisement before the impression interactive advertisement. The Marketing Report 500 may be generated and stored in the Database 114 wherein the Advertiser 118 may electronically view the Marketing Report 500. Alternatively, the Marketing Report 500 may be electronically transmitted to the Advertiser 118.

According to alternative embodiments of the present invention, marketing reports of greater complexity may be generated. For example, the effectiveness of a series a three or more interactive advertisements may be analyzed. Alternatively, two different type-in interactive advertisements may be related to the single impression interactive advertisement to test the effectiveness of each type-in interactive advertisement. Furthermore, any addition marketing report may be generated based on the information collected by the Interactive Advertisement Generation System 102.

It is to be understood that the exemplary embodiments are merely illustrative of the invention and that many variations of the above-described embodiments may be devised by one skilled in the art without departing from the scope of the invention. It is therefore intended that all such variations be included within the scope of the following claims and their equivalents.

What is claimed is:

1. A computer-implemented method comprising:
receiving, by a computer, a request for content from a user;
identifying, by the computer, an advertiser based on a user dataset;
providing, by the computer, an interactive advertisement associated with the advertiser comprising:
a media segment,
a branding message, and
a user input segment configured to receive a user response;
transmitting, by the computer, the interactive advertisement to a user;
receiving, by the computer, the user response;
verifying, by the computer, the user response based on at least a portion of the branding message; and
providing, by the computer, access to the content based on the user response.

2. The computer-implemented method of claim 1, wherein the media segment is a pre-roll video advertisement.

3. The computer-implemented method of claim 1, wherein the user input segment is configured to receive the user response as text entered by the user.

4. The computer-implemented method of claim 1, wherein the user input segment comprises a drop down menu configured to allow the user response to be selected from the drop down menu.

5. The computer-implemented method of claim 1, wherein the interactive advertisement is generated by the computer.

6. A system for verifying a user response, comprising:
an advertisement creation computer module configured to:
receive a request for content from a user,
identify an advertiser based on a user dataset,
generate an interactive advertisement, comprising:
a media segment,
a branding message, and
a user input segment configured to receive the user response, and
verify the user response based on at least a portion of the branding message; and
a user interface computer module communicatively connected to the advertiser creation computer module configured to:
transmit the interactive advertisement to the user,
receive the user response, and
providing access to the content based on the user response.

7. The system of claim 6, wherein the media segment is a pre-roll video advertisement.

8. The system of claim 6, wherein the user input segment is configured to receive the user response as text entered by the user.

9. The system of claim 6, wherein the user input segment comprises a drop down menu configured to allow the user response to be selected from the drop down menu.

10. A non-transitory computer readable medium comprising executable instructions, the instructions being executed by a processor to perform a method, the method comprising:
receiving, by an advertisement creation module, a request for content from a user;
identifying, by the advertisement creation module, an advertiser based on a user dataset;
providing, by the advertisement creation module, an interactive advertisement associated with the advertiser comprising:
a media segment,
a branding message, and
a user input segment configured to receive a user response;
transmitting, by a user interface computer module, the interactive advertisement to a user;
receiving, by the user interface computer module, the user response;
verifying, by the advertisement creation module, the user response based on at least a portion of the branding message; and
providing, by the user interface computer module, access to the content based on the user response.
